(19) United States
(12) Patent Application Publication
(10) Pub. No.: US 2022/0301379 A1
(43) Pub. Date: Sep. 22, 2022

(54) MONEY STORAGE CONTAINER AND MONEY PROCESSING DEVICE

(71) Applicant: Glory Ltd., Himeji-shi (JP)

(72) Inventor: Eiki YAMAMOTO, Himeji-shi (JP)

(73) Assignee: Glory Ltd., Himeji-shi (JP)

(21) Appl. No.: 17/832,702

(22) Filed: Jun. 6, 2022

Related U.S. Application Data
(63) Continuation of application No. PCT/JP2020/043376, filed on Nov. 20, 2020.

(30) Foreign Application Priority Data
Dec. 6, 2019 (JP) 2019-221637

(51) Int. Cl. G07D 11/12; G07D 11/40; B65H 31/22

(52) U.S. Cl. CPC G07D 11/12; G07D 11/40; B65H 31/22; G07D 2211/00; B65H 2701/1912

(57) ABSTRACT

A money storage container, in which a money handling apparatus stores money, includes: a bag body having an opening, and configured to store the money therein through the opening; and a frame disposed at the opening of the bag body, and having a gate for opening and closing the opening. The frame is configured to be mounted to and dismounted from the money handling apparatus.

### CROSS-REFERENCE TO RELATED APPLICATIONS

The present application is a continuation of, and claims priority to, International application PCT/JP2020/043376, filed Nov. 20, 2020, which claims priority to JP 2019-221637, filed Dec. 6, 2019, and the entire contents of both are incorporated herein by reference.

### TECHNICAL FIELD

The present disclosure relates to a money storage container for storing money, and a money handling apparatus that stores money in the money storage container.

### BACKGROUND

Conventionally, a money handling apparatus that stores money in a money storage container has been used. For example, U.S. Pat. No. 9,080,368 discloses a storage bag for storing banknotes. An opening of the storage bag can be closed. Two solid members are fixed to the opening of a flexible bag. One of the members is provided with a plurality of shafts each having an umbrella-shaped top portion, and the other member is provided with holes corresponding to the respective shafts. The diameter of each hole is smaller than the maximum diameter of the umbrella-shaped portion of the corresponding shaft to prevent the shaft inserted in the hole from coming off. After banknotes are stored in the storage bag, the shafts of the one member are inserted in the holes of the other member, whereby the opening of the storage bag can be closed to prevent the banknotes from being taken out of the bag.

### SUMMARY

The storage bag of the conventional art may not be suitable for use in a money handling apparatus that automatically stores money into the storage bag and close the opening of the storage bag. For example, in a case where the money handling apparatus stacks a predetermined quantity of money and then stores the money together into the storage bag, a unit for stacking the money needs to be provided in the money handling apparatus separately from the storage bag.

The present disclosure is made in view of the problem, as well as other problems, of conventional arts. The present disclosure addresses the issues, as discussed herein, with a money storage container suitable for use in a money handling apparatus, and a money handling apparatus that uses the money storage container.

The present disclosure provides a money storage container according to the present disclosure is a container in which a money handling apparatus stores money. The container includes: a bag body having an opening, and configured to store the money therein through the opening; and a frame disposed at the opening of the bag body, and having a gate for opening and closing the opening. The frame is configured to be mounted to and dismounted from the money handling apparatus.

The present disclosure also provides a money handling apparatus including: a mounting unit to/from which the money storage container having the above configuration is mounted/dismounted; and a storage mechanism configured to store the money in the money storage container, and close the opening after storing the money.

### BRIEF DESCRIPTION OF THE DRAWINGS

FIG. 1 is a schematic cross-sectional view showing a configuration of a banknote handling apparatus according to an embodiment of the present disclosure.

FIG. 2 illustrates a method for mounting/dismounting a storage bag to/from a mounting unit drawn out from a storage mechanism.

FIG. 3 illustrates a method for storing banknotes in the storage bag.

FIGS. 4A to 4C illustrate a bag portion of the storage bag.

FIGS. 5A and 5B illustrate a frame of the storage bag.

FIG. 6 illustrates a method for mounting/dismounting the storage bag.

FIGS. 7A to 7C illustrate stacking and storage of banknotes.

FIG. 8 illustrates a part of the storage mechanism.

FIG. 9 illustrates a detection member.

FIG. 10 illustrates a pressing member.

FIGS. 11A to 11D are schematic diagrams illustrating a pushing process.

FIG. 12 is a flowchart illustrating a sealing process.

FIGS. 13A to 13D are schematic diagrams illustrating an upper-end detection process.

FIGS. 14A to 14D are schematic diagrams illustrating a sealing process.

FIGS. 15A to 15C illustrate other examples of stages.

FIGS. 16A to 16C show other examples of connecting portions for closing the frame.

### DETAILED DESCRIPTION OF THE DRAWINGS

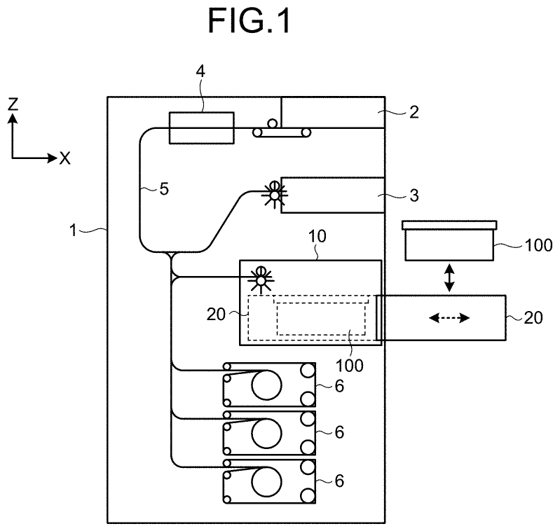

Hereinafter, a money storage container and a money handling apparatus that stores money in the money storage container, according to an embodiment of the present disclosure, will be described with reference to the drawings. FIG. 1 is a schematic cross-sectional view showing a configuration of a banknote handling apparatus 1. The banknote handling apparatus 1 is an example of the money handling apparatus according to the present embodiment configured to handle money. The banknote handling apparatus 1 is the money handling apparatus that handles banknotes as an example of money (cash). In each drawing showing the apparatus configuration of the present embodiment, three axes X, Y, and Z orthogonal to each other are shown so that the relationship between components shown in each drawing can be understood. As for components to be mounted/dismounted, directions in their mounted states are indicated by the three axes.

As shown in FIG. 1, the banknote handling apparatus 1 includes a storage mechanism 10. The storage mechanism 10 includes a mounting unit 20 to/from which a storage bag 100 can be mounted/dismounted. The storage bag 100 is a money storage container for storing banknotes as an example of money. For example, as shown by a solid line in FIG. 1, the storage bag 100 can be mounted/dismounted, from the upper side, to/from the mounting unit 20 that has been drawn out from the storage mechanism 10 disposed inside a housing of the banknote handling apparatus 1. The mounting/dismounting direction is not limited to the vertical direction. The storage bag 100 may be mountable/dismountable from the lateral side of the mounting unit 20. As shown by a broken line in FIG. 1, the mounting unit 20 to which the storage bag 100 is mounted can be returned into the storage mechanism 10. Preferably, the banknote handling apparatus 1 may include a transport unit 5 for transporting banknotes. The storage mechanism 10 receives banknotes transported by the transport unit 5, and stores the banknotes in the storage bag 100 mounted to the mounting unit 20.

More preferably, the banknote handling apparatus 1 may include an inlet 2, an outlet 3, a recognition unit 4, and storage units 6. The banknote handling apparatus 1 can perform dispensing and depositing of banknotes. The number of storage units 6 is not particularly limited although FIG. 1 shows an example in which a plurality of storage units 6 are disposed. Each storage unit 6 is configured to store banknotes therein and feed out the stored banknotes therefrom. In the dispensing process, banknotes to be dispensed, among the banknotes stored in the storage units 6, are fed out from the storage units 6. The transport unit 5 transports the banknotes fed out from the storage units 6. The banknotes transported by the transport unit 5 reach the outlet 3, and are discharged to outside the banknote handling apparatus 1 through the outlet 3.

In the depositing process, banknotes to be deposited are fed one by one into the apparatus from the inlet 2. The transport unit 5 transports the banknotes fed into the apparatus. The recognition unit 4 recognizes and counts banknote each of which is transported by the transport unit 5. For example, the recognition unit 4 recognizes denomination, fitness, and authenticity of each banknote, and counts the number of banknotes for each denomination, the total number of banknotes, and the total amount of banknotes. Hereinafter, recognition process of banknotes may include counting of the banknotes. Each banknote recognized by the recognition unit 4 is transported to any of the storage units 6, the storage mechanism 10, and the outlet 3 according to the recognition result. A kind of banknotes to be stored therein can be set to each of the storage units 6. For example, a denomination of banknotes to be stored therein is set to each storage unit 6. A banknote, which is determined that it cannot be deposited as a result of the recognition by the recognition unit 4, is discharged as a reject banknote from the outlet 3. For example, a banknote that cannot be recognized by the recognition unit 4 and a banknote that is recognized as a counterfeit note by the recognition unit 4 are discharged from the outlet 3. Meanwhile, a banknote that can be deposited is stored in the storage unit 6 corresponding to the kind of the banknote, based on the recognition result by the recognition unit 4. For example, banknotes are stored in the plurality of storage units 6 by denomination.

For example, each storage unit 6 is configured to reel up banknotes together with tapes onto an outer circumferential surface of a drum rotating to store the banknotes, and to feed out the stored banknotes to the transport unit 5 by the drum rotating in a direction opposite to the direction to store the banknotes. This configuration is an example of the storage unit 6. The configuration of the storage unit 6 is not particularly limited as long as the storage unit 6 is configured to store banknotes therein. The storage bag 100 mounted to the mounting unit 20 of the storage mechanism 10 stores banknotes therein but does not feed out banknotes. For example, when a storage unit 6 is full of banknotes and an additional banknote cannot be stored therein, this banknote is transported to the storage mechanism 10 and stored in the storage bag 100. For another example, a banknote, which can be deposited but whose denomination is set to none of the storage units 6, is transported to the storage mechanism 10 and stored in the storage bag 100. The storage bag 100 is also used for a collection process of collecting banknotes from the storage unit 6s, to outside the apparatus. Specifically, banknotes to be collected are fed out from the storage units 6, transported to the storage mechanism 10, and stored in the storage bag 100. The storage mechanism 10 can close an opening of the storage bag 100 having the banknotes stored therein. A person in charge of banknote collection can draw out the mounting unit 20 from the storage mechanism 10 as shown in FIG. 1, take out the storage bag 100 upward from the mounting unit 20, and collect the banknotes stored in the storage bag 100 together with the storage bag 100.

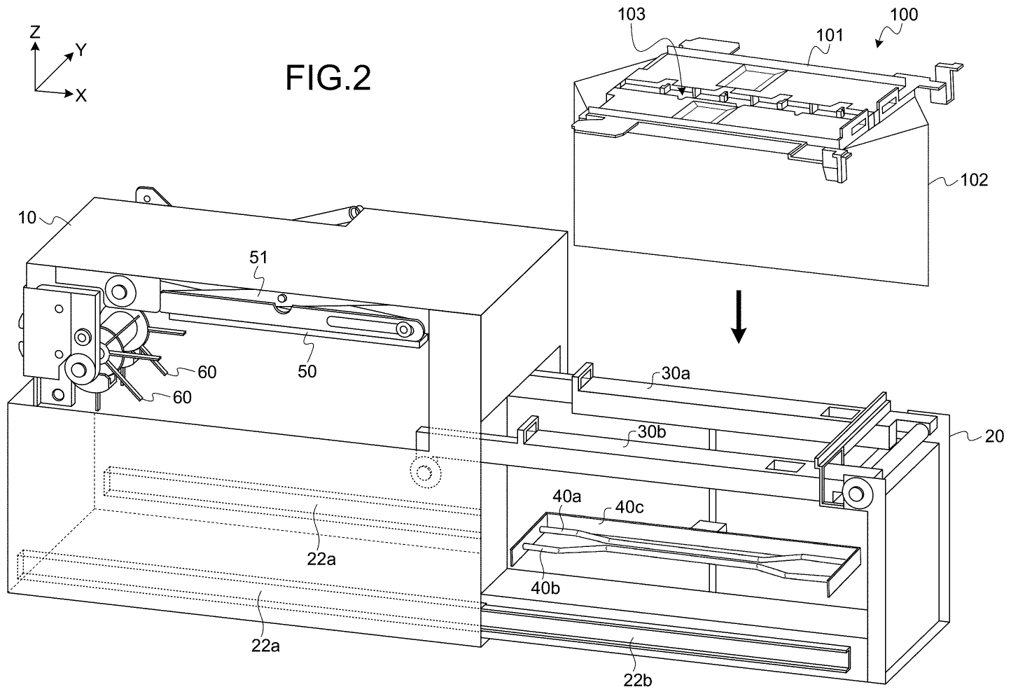

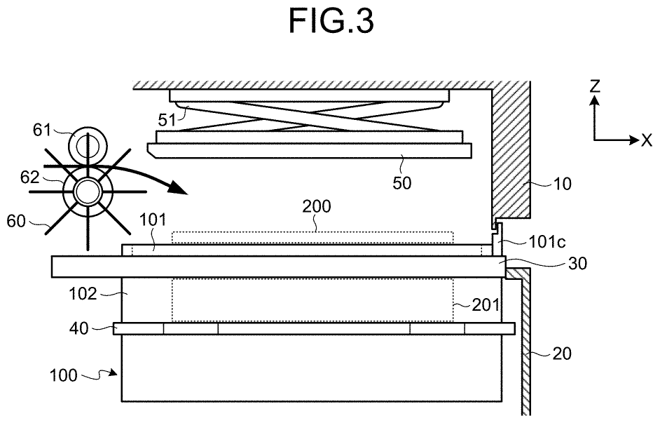

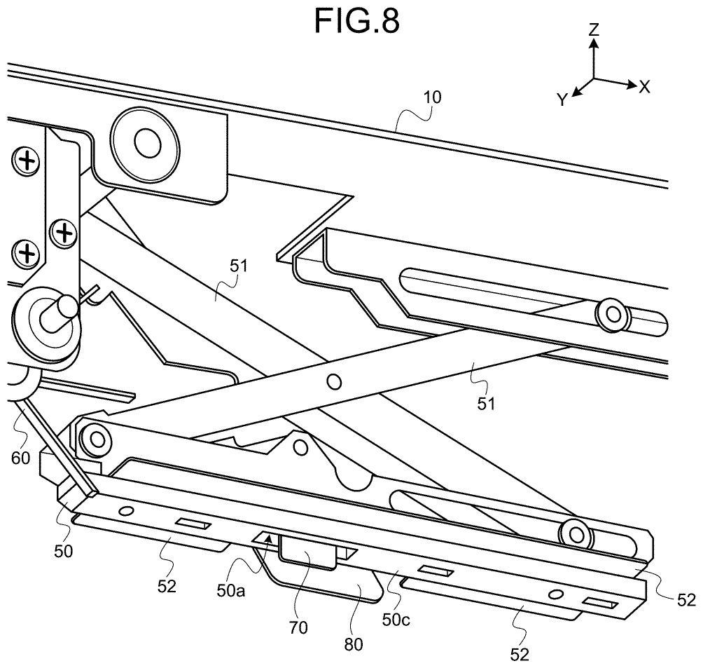

FIG. 2 illustrates a method for mounting/dismounting the storage bag 100 to/from the mounting unit 20 drawn out from the storage mechanism 10. FIG. 3 illustrates a method for storing banknotes into the storage bag 100. Although not shown in FIG. 2 and FIG. 3, the storage mechanism 10 includes: a detection member 70 that detects an upper end of the banknotes stored in the storage bag 100; a pressing member 80 that presses the banknotes stored in the storage bag 100; and a pushing film 52 that assists pushing of the banknotes by a pushing member 50 (see FIG. 8). These components will be described later.

As shown in FIG. 2, inner side walls of the storage mechanism 10 are connected to outer side walls of the mounting unit 20 by a plurality of slide rails 22 (22a, 22b) that constitute a connecting member of the storage mechanism 10 and the mounting unit 20. The slide rails 22 (22a, 22b) are an example of the connecting member. The configuration of the connecting member is not particularly limited as long as the storage mechanism 10 and the mounting unit 20 are connected to each other such that the mounting unit 20 can be drawn out from the storage mechanism 10. The rails 22b fixed to the mounting unit 20 slide with respect to the rails 22a fixed to the storage mechanism 10. This allows the mounting unit 20 to move between a position drawn out from the apparatus as shown in FIG. 2 and a position in the apparatus where banknotes are stored in the storage bag 100 as shown in FIG. 3.

FIG. 2 shows an example of the mounting unit 20 having a box shape. An upper surface of the mounting unit 20 is opened such that the storage bag 100 can be mounted/dismounted from the upper side. The box shape of the mounting unit 20 is an example. The configuration of the mounting unit 20 is not particularly limited as long as the storage bag 100 can be mounted thereto. For example, instead of the upper surface, a side surface of the mounting unit 20 may be opened such that the storage bag 100 can be mounted/dismounted from the lateral side. A holder mechanism for holding a part of the storage bag 100 near the opening of the storage bag 100 is disposed at an upper part of the mounting unit 20. The holder mechanism includes a holder 30 (30a, 30b) that is a pair of holders 30a, 30b disposed facing each other, for example. Preferably, the holder 30a and the holder 30b are disposed facing each other with the upper surfaces thereof being substantially horizontal. The position of the holder 30a is fixed. The holder 30b, disposed away in the horizontal direction (Y-axis direction) from the holder 30a, is movable in the Y-axis direction. A holder driving unit drives the holder 30b to move.

A stage 40 is disposed beneath the holder 30. For example, the stage 40 includes a pair of opposing members 40a, 40b disposed facing each other. The configuration of the stage 40 is not limited to that including the pair of opposing members 40a, 40b, as long as a part of a bag body 102 of the storage bag 100 mounted to the mounting unit 20 can be placed on the stage 40 and supported by the stage 40 from the lower side. The pair of opposing members 40a. 40b are disposed such that a lower part of the bag body 102, which is placed on the stage 40, can be inserted between the opposing members 40a, 40b. This allows the lower part of the bag body 102, which is placed on the stage 40, is sandwiched between the pair of opposing members 40a, 40b. The material of the opposing members 40a, 40b is not particularly limited. For example, the opposing members 40a, 40b are formed of a resin or a metal. The pair of opposing members 40a. 40b are disposed facing each other, and one member 40a is preferably disposed away from the other member 40a in the horizontal direction (Y-axis direction). More preferably, the stage 40 includes a support member 40c that supports the pair of opposing members 40a, 40b. For example, each of the opposing members 40a, 40b has a round bar shape. The opposing members 40a, 40b may not necessarily have the round bar shape, and may have any shape as long as parts thereof being in contact with the bag body 102 have curved surfaces so as not to tear the bag body 102. Specifically, at least facing inner-side parts of the opposing members 40a, 40b may be curved in a cross section. A gap between the opposing members 40a, 40b is wider at both outer sides than at the center part. That is, the pair of opposing members 40a. 40b disposed facing each other have: center parts having a gap of a constant width; and both outer-side parts that have a wider gap than the center parts and are connected to the center parts. Specifically, each of the opposing members 40a, 40b has: a center part parallel to the X-axis; expanding parts that are bent outward, in a horizontal plane (XY plane), at both outer sides of the center part having a predetermined length so that the gap is gradually increased; and both end parts that are bent again in the opposite direction so as to be parallel to the center part after the gap has been increased to a predetermined width by the expanding parts. For example, the opposing members 40a, 40b are formed such that the length, in the axial direction (X-axis direction), of the center part having the gap of the constant width is equal to or greater than ½ of the dimension of the long edge of the banknote to be supported by the stage 40. The width, in the Y-axis direction, of the gap between the center parts of the stage 40 is wider than the thickness of the bag body 102 that is being folded such that at least a part of the bag body 102 can be inserted therein. The width of the gap between the center parts is adjusted to prevent a bundle of banknotes which are stored in the bag body 102 from falling below the stage 40 through the gap in the bag body 102. The stage 40 is movable in the up-down direction (Z-axis direction). A spring member that urges the stage 40 toward the holder 30 is attached to the support member 40c of the stage 40. The position of the stage 40 can be controlled by a stage driving unit that moves the support member 40c in the up-down direction. While the pushing member 50 pushes banknotes into the storage bag 100, the stage 40 is urged upward by the spring member. The stage driving unit controls the position of the stage 40 when detection of an upper end of the banknotes in the storage bag 100 is performed and when a frame 101 of the storage bag 100 is closed. The operation of the stage 40 will be described later in detail.

As indicated by an arrow in FIG. 2, the storage bag 100 is mounted from the upper opening of the mounting unit 20. The storage bag 100 includes the frame 101 and the bag body 102. The periphery of the opening of the bag body 102 is fixed to the side surfaces of the frame 101. Preferably, the entire periphery of the opening of the bag body 102 is adhered to the outer peripheral side surface of the frame 101, whereby the bag body 102 is fixed to the frame 101. Materials of the frame 101 and the bag body 102 are not particularly limited. Preferably the frame 101 is formed of a hard material while the bag body 102 is formed of a soft material that is foldable. For example, the frame 101 is formed of non-transparent hard resin and the bag body 102 is formed of non-transparent nylon. Banknotes transported to the storage mechanism 10 by the transport unit 5 can be stored inside the bag body 102.

The bag body 102 has a plurality of through-holes having a diameter of a few millimeters. For example, if someone tries to break the banknote handling apparatus 1 and steal the storage bag 100, the banknote handling apparatus 1 detects this abnormality and sprays antitheft ink toward the storage bag 100. The sprayed ink enters the storage bag 100 through the through-holes and adheres to the banknotes. The ink stained banknotes can be identified as stolen banknotes.

The storage bag 100 is mounted to the mounting unit 20 by inserting the bag body 102 into the gap between the opposing members 40a. 40b of the stage 40 and fixing the frame 101 to the holder 30. As shown in FIG. 2, the frame 101 has an opening 103 through which banknotes are passed. Banknotes pass through the opening 103 of the frame 101 and are stored inside the bag body 102. Preferably, for example, the opening 103 is formed at substantially the center in the lateral direction (Y-axis direction) of the frame 101 and has a substantially rectangular shape that is long in the longitudinal direction (X-axis direction). The frame 101 includes a gate for opening and closing the opening 103. Banknotes can pass through the opening 103 while the gate is open, but cannot pass through the opening 103 while the gate is closed. The gate will be described later in detail.

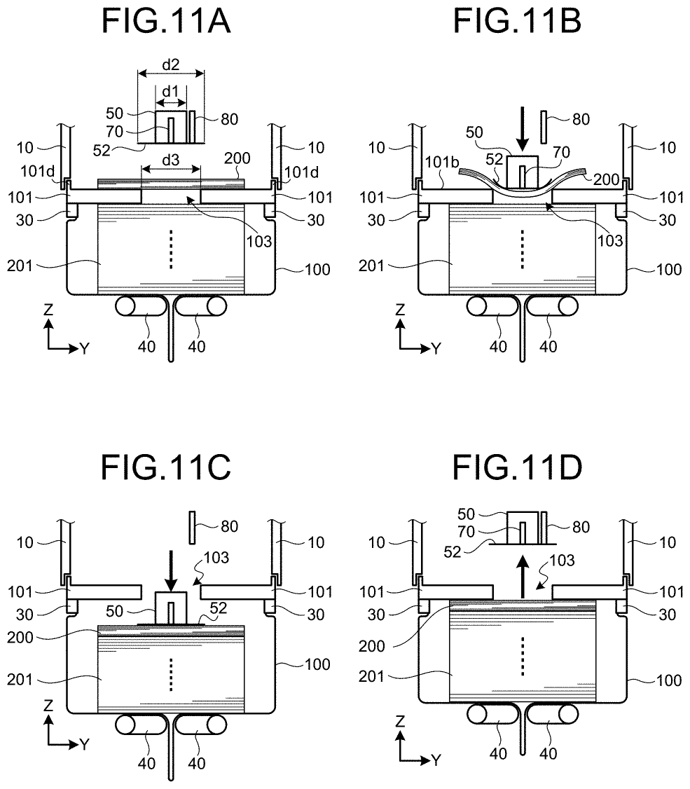

When the mounting unit 20, to which the storage bag 100 has been mounted, is returned into the storage mechanism 10 and banknote handling is started, the storage mechanism 10 stacks banknotes 200 on the frame 101 as shown in FIG. 3. A plurality of banknotes 200 are stacked on the frame 101 that is a banknote stacking area in the storage mechanism 10. Preferably, the storage mechanism 10 is provided with a plurality of stacking wheels 60, a plurality of rollers 61, 62 and the like. The rollers 61, 62 are disposed facing each other with outer circumferential surfaces thereof being in contact with each other. Each stacking wheel 60 has a plurality of blades disposed at equal angular intervals on an outer circumferential surface thereof. Preferably, the storage mechanism 10 is provided with a pushing member 50 that pushes the banknotes 200 stacked on the frame 101 of the storage bag 100 into the bag body 102. The pushing member 50 is configured to move in the up-down direction. For example, the storage mechanism 10 is provided with a pantograph arm 51 that supports the pushing member 50 movably in the up-down direction. A pushing member driving unit drives the arm 51 to expand and contract in the up-down direction to move the pushing member 50 in the up-down direction. The configuration for moving the pushing member 50 in the up-down direction is not limited to that using the pantograph arm 51 as long as the pushing member 50 can move in the up-down direction. The pushing member 50 moves in the up-down direction between a retracted position shown in FIG. 3 and a pushing position at which banknotes are pushed into the storage bag 100 (see FIGS. 11A to 11D), which will be described later in detail.

As shown in FIG. 3, the upper surface of the frame 101 mounted to the holder 30 forms a stacking area for stacking the banknotes 200 fed into the storage mechanism 10. The stacking area corresponds to a boundary part between a stacking space for stacking the banknotes 200 and another space in the storage mechanism 10. That is, the banknotes 200 fed into the storage mechanism 10 are stacked in the stacking area, on the upper surface of the frame 101 mounted to the holder 30 in the storage mechanism 10, which composes the boundary part of the stacking space. The banknote handling apparatus 1 stacks the banknotes 200 transported by the transport unit 5 on the frame 101 used as the stacking area in the storage mechanism 10. Preferably, the banknote handling apparatus 1 drives the rollers 61, 62 and the stacking wheels 60 to rotate, whereby the banknotes 200 are stacked on the frame 101. As indicated by an arrow in FIG. 3, a banknote transported by the transport unit 5 passes between the rollers 61, 62 to enter the stacking space, and is sent onto the frame 101 by the stacking wheel 60. The configuration of the storage mechanism 10 including the rollers 61, 62 and the stacking wheels 60 for stacking the banknotes 200 on the stacking area on the frame 101 is an example and the storage mechanism 10 is not limited thereto.

The frame 101 has a shape that prevents the banknotes 200 from jumping out from the frame 101, i.e., from the stacking area. Specifically, as shown in FIG. 3, the frame 101 includes a projection 101c that projects upward from the upper surface on which the banknotes 200 are stacked. The projection 101c is disposed at a position ahead in the moving direction of the banknote fed out by the stacking wheels 60. The projection 101c is in contact with at least a part of the side wall of the storage mechanism 10 to fill the gap between the frame 101 and the storage mechanism 10. Thus, even when a banknote being transported at a high speed by the transport unit 5 is vigorously fed out in the X-axis positive direction by the stacking wheels 60, this banknote is prevented from jumping out through the gap between the storage mechanism 10 and the frame 101.

The upper surface of the frame 101 serves as a stacking surface, on which the banknotes 200 are stacked, in the stacking area of the storage mechanism 10. The upper surface of the frame 101 mounted to the holder 30 is substantially horizontal. As indicated by a broken line in FIG. 3, the banknotes 200 are stacked on the frame 101 with the faces thereof being parallel to the upper surface of the frame 101. When the number of the stacked banknotes 200 has reached a predetermined number (e.g., 10), the pushing member 50 moves downward and pushes the banknotes 200 into the bag body 102 through the opening 103 of the frame 101. The banknotes 201 pushed into the bag body 102 are supported by the stage 40 from the lower outside of the bag body 102 such that the banknote faces are substantially horizontal. The pushing member 50 pushes the banknotes 200 from the upper side while the stage 40 supports the banknotes 201 from the lower side. It enables that the plurality of banknotes 200, 201 are stored in an aligned and stacked state inside the bag body 102 formed of a deformable material. The position of the stage 40 urged upward by the spring member is adjusted in the up-down direction according to the number of the banknotes stored in the bag body 102. When the banknotes 200 pushed by the pushing member 50 are added onto the banknotes 201 shown in FIG. 3, the stage 40 moves downward according to the number of the added banknotes 200.

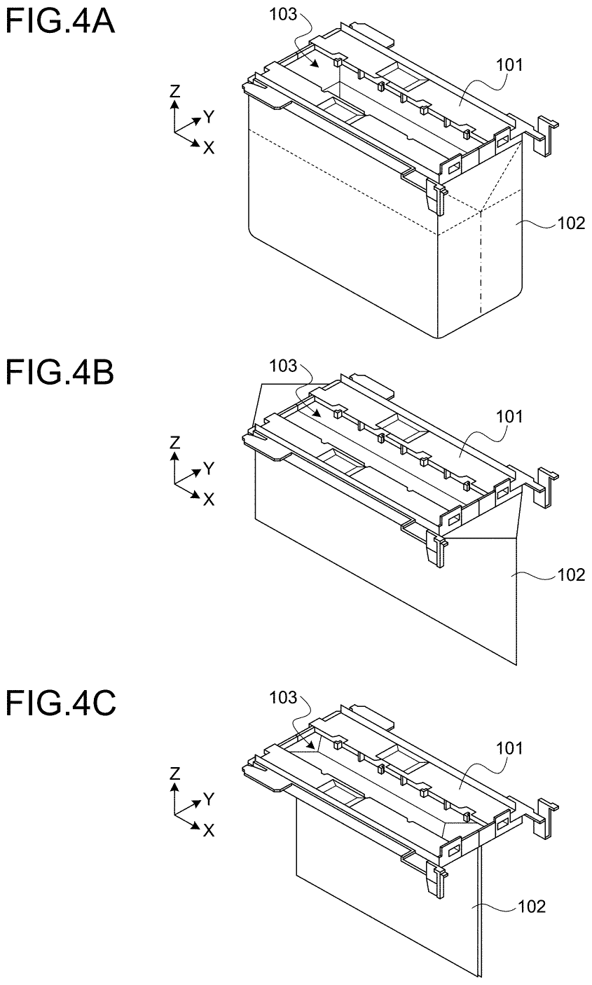

FIGS. 4A to 4C illustrate the bag body 102 of the storage bag 100. As shown in FIG. 4A, the bag body 102 has a substantially rectangular parallelepiped shape. The storage bag 100 can store several hundreds of banknotes, in a stacked state, which are pushed therein from the opening 103 of the frame 101 by the pushing member 50. Although the number of storable banknotes varies depending on the degree of damage of the banknotes, the storage bag 100 can store therein 400 to 600 banknotes, for example.

A lower part of the bag body 102 has a folded shape as shown in FIGS. 4B and 4C before banknotes are stored therein. i.e., when banknotes are not stored inside the bag body 102. For example, when the bag body 102 is folded at a position indicated by a broken line in FIG. 4A such that a substantially center part of a short-side lateral surface of the bag body 102 indicated by an alternate long and short dash line in FIG. 4A protrudes outward, the bag body 102 is folded as shown in FIG. 4B. Alternatively, when the bag body 102 is folded at the position indicated by the broken line in FIG. 4A such that the part indicated by the alternate long and short dash line in FIG. 4A protrudes inward, the bag body 102 is folded as shown in FIG. 4C. Since the lower part of the bag body 102 is made flat by folding the bag body 102 as shown in FIG. 4B or 4C, the bag body 102 can be inserted easily into the gap between the two opposing members 40a. 40b of the stage 40 shown in FIG. 2. Even when the length, in the X-axis direction, of the bag body 102 folded as shown in FIG. 4B is longer than the length of the stage 40 in the X-axis direction shown in FIG. 2, since the gaps between the opposing members 40a, 40b at the both outer sides are wide, the both outer parts of the bag body 102 can be easily inserted in these gaps. The flat shape of the folded bag body 102 refers to a shape that is realized by folding at least a part of the bag body 102, which can form a banknote storage space as shown in FIG. 4A, so as to make a lower part of the bag body 102 flat and reduce the banknote storage space. The lower part of the bag body 102 may not necessarily be fully flat as long as the lower part can be inserted in the gap between the two opposing members 40a, 40b of the stage 40. A part of the bag body 102 may be inflate and/or may form a curved surface.

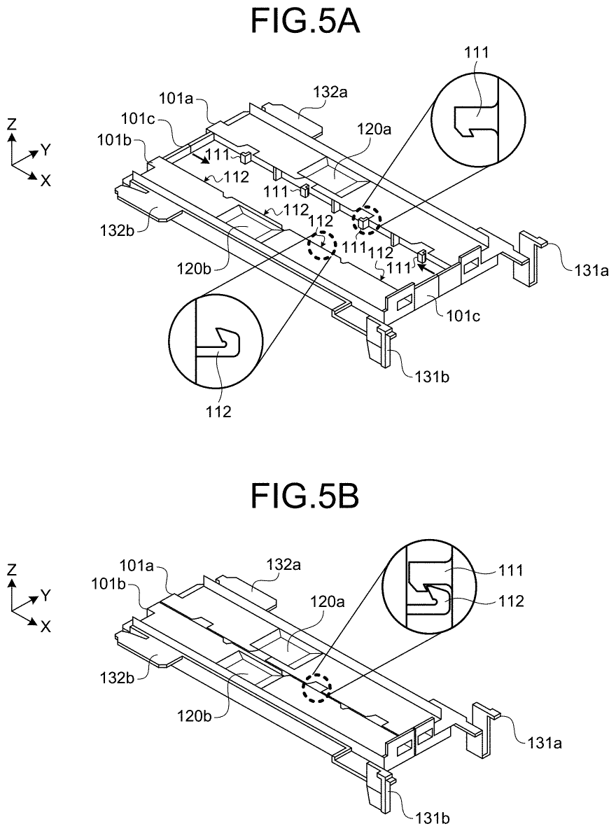

FIGS. 5A and 5B illustrate the frame 101 of the storage bag 100. Although the bag body 102 is not shown in FIGS. 5A and 5B, the opening of the bag body 102 is fixed to the side surfaces of the frame 101 by using an adhesive. FIG. 5A shows a state where the opening 103 of the frame 101 is opened, and FIG. 5B shows a state where the opening 103 of the frame 101 is closed. When the opening 103 is in the opened state as shown in FIG. 5A, the opening of the storage bag 100 is open. In the opened state shown in FIG. 5A, banknotes can be stacked onto the frame 101, and the stacked banknotes can be pushed into the bag body 102 from the opening 103 of the frame 101, and stored in the bag body 102.

As shown in FIG. 5A, the frame 101 includes a pair of frame members 101a, 101b disposed facing each other. The pair of frame members 101a, 101b function as the aforementioned gate. When the opening 103 of the frame 101 is open, i.e., the opening of the storage bag 100 is open, the frame members 101a, 101b constituting the gate are separated away from each other. When the frame members 101a, 101b constituting the gate move and come into contact with each other, the opening 103 of the frame 101 is closed. The opening of the storage bag 100 is closed by closing the opening 103 of the frame 101. Preferably, the frame 101 may further include two connection members 101c that connect the both ends of the respective frame members 101a, 101b. Each connection member 101c is bendable in a direction indicated by an arrow in FIG. 5A. When at least one of the frame member 101a and the frame member 101b is moved in the Y-axis direction, the connection members 101c bend and the substantially center parts thereof move toward inside the frame 101 as indicated by the arrows in FIG. 5A, whereby the opening 103 of the frame 101 is closed.

The opening 103 is formed by a plurality of members 101a, 101b, and 101c. As shown in enlarged views in FIG. 5A, on the side surface of the frame member 101a facing the frame member 101b, a plurality of connecting portions 111 are disposed. Meanwhile, on the side surface of the frame member 101b facing the frame member 101a, a plurality of connecting portions 112 are disposed so as to be connectable with the corresponding connecting portions 111. For example, each connecting portion 111 and each connecting portion 112 may have shaft parts as hook bodies disposed on the side surfaces of the frame members 101a, 101b, respectively, and hook parts for mutual engagement. The hook parts of the connecting portion 111 and the connecting portion 112 may not necessarily have the above described shape, and may have any shape as long as the connecting portion 111 and the connecting portion 112 can be engaged with each other. One connecting portion 111 and one corresponding connecting portion 112 form a pair of connecting portions, and a plurality of pairs may be disposed at unequal intervals in the longitudinal direction. For example, the number of connecting portions 111, 112 disposed at both outer parts is larger than the number of connecting portions 111, 112 at the center part in the longitudinal direction so that the connecting portions 111 are not disconnected from the corresponding connecting portions 112 when twisting force is applied to the frame members 101a, 101b while the gate is closed by closing the opening 103 as shown in FIG. 5B.

At the tips of the hook bodies of the connecting portions 111, 112, hook-shaped projections (hook parts) are formed so as to be engaged with each other when the opening 103 is closed to close the gate, as shown in an enlarged view in FIG. 5B. The shaft part as the hook body of the connecting portion 111 is thicker than that of the connecting portion 112. When the opening 103 is closed, the connecting portion 112 elastically deforms and bows outward while the projection of the connecting portion 112 passes through the position of the projection of the corresponding connecting portion 111. The connecting portion 112 returns to its original shape after the projection of the connecting portion 112 has passed the position of the projection of the connecting portion 111, whereby the projection of the connecting portion 112 is engaged with the projection of the connecting portion 11. The opening 103 is closed with the members 101a, 101b that are fixed by engaging the connecting portion 111 and the connecting portion 112 with each other as shown in the enlarged view in FIG. 5B. When the opening 103 is closed, the connecting portions 111, 112 are hidden behind the frame 101 and are invisible from outside the storage bag 100.

In a configuration of some conventional arts, a shaft having an umbrella-shaped tip is pushed into a hole having a diameter smaller than that of the shaft, in order to close the opening 103 by closing the gate of the frame 101. In this configuration, when the process of closing the opening 103 of the frame 101 is to be automated, great driving force for pushing the umbrella-shaped tips into the holes is required. By adopting the configuration shown in FIGS. 5A and 5B, the process of closing the opening 103 of the frame 101 can be easily automated with smaller driving force as compared to the conventional art.

If the gate of the frame 101 is once closed with the projections of the connecting portions 111, 112 being engaged with each other, the gate cannot be opened. If the once closed gate of the frame 101 is forcibly opened, at least either the connecting portions 111 or the connecting portions 112 engaged with each other are broken. For example, if the connecting portions 112 are broken, the broken connecting portions 112 fall from the frame member 101b on which the connecting portions 112 have been disposed. Preferably, when the projections of the connecting portions 111 are engaging with the projections of the connecting portions 112, the connecting portions 112 having the thinner shaft parts than the connecting portions 111 are broken. The broken connecting portions 112 fall into the bag body 102. For example, after banknotes are stored in the storage bag 100, the opening 103 of the frame 101 is closed and the storage bag 100 with the closed frame 101 is collected from the banknote handling apparatus 1 and carried to a financial institution. In the financial institution, the bag body 102 is tom and the banknotes are taken out from the storage bag 100 without opening the opening 103 of the frame 101. Therefore, if the opening 103 of the frame 101 was opened or tried to be opened after the banknote handling apparatus 1 closed the opening 103 of the frame 101, it can be found according to whether or not the broken connecting portions 112 are present in the tom bag body 102.

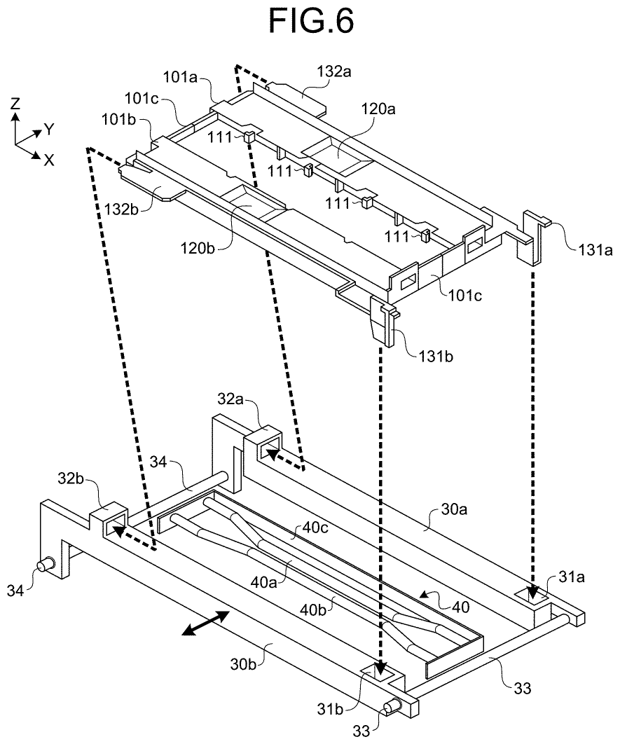

FIG. 6 illustrates a method for mounting/dismounting the storage bag 100. In FIG. 6, illustration of the bag body 102 is omitted. The frame 101 has a plurality of insertion portions 131 (131a, 131b) and 132 (132a, 132b). The insertion portions 131 have a plate spring shape with a projection that allows snap-fit mounting/dismounting.

The insertion portion 132a insertable in a hole formed substantially in the horizontal direction (X-axis direction) is disposed at one end of the longitudinal side surface of the frame member 101a, and the insertion portion 131a for snap-fit to be inserted in a hole formed substantially in the vertical direction (Z-axis direction) is disposed at the other end of the frame member 101a. Likewise, the insertion portion 132b insertable in a hole formed substantially in the horizontal direction is disposed at one end of the longitudinal side surface of the frame member 101b, and the insertion portion 131b for snap-fit to be inserted in a hole formed substantially in the vertical direction is disposed at the other end of the frame member 101b. In the holder 30, holes 32 (32a, 32b) corresponding to the respective insertion portions 132 are formed substantially in the horizontal direction, and holes 31 (31a, 31b) for snap-fit corresponding to the respective insertion portions 131 are formed substantially in the vertical direction.

Each hole 31 of the holder 30 has a dimension that conforms with deformation of the corresponding plate-spring-shaped insertion portion 131. A groove corresponding to the projection of the insertion portion 131 is formed inside the hole 31. When the insertion portion 131 is inserted into the hole 31, the plate-spring-shaped insertion portion 131 elastically deforms in the Y-axis direction. Then, the shape of the insertion portion 131 returns to its original shape at a position where the projection of the insertion portion 131 is fitted in the groove inside the hole 31, whereby the position of the insertion portion 131 is fixed with respect to the hole 31. When force is applied to the plate-spring-shaped insertion portion 131 so as to release the projection of the insertion portion 131 from the groove inside the hole 31 and to pull the insertion portion 131 upward, the projection of the insertion portion 131 is released from the groove inside the hole 31 and the insertion portion 131 can be pulled out from the hole 31.

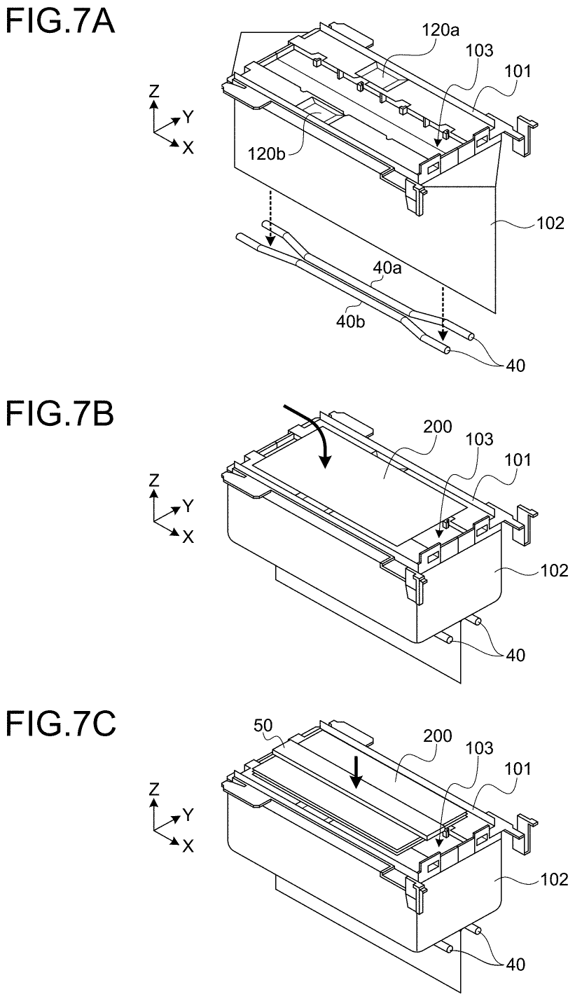

Although the bag body 102 is not shown in FIG. 6, a folded bag body 102 is inserted in the gap between the two opposing members 40a, 40b of the stage 40 (see FIG. 7A). As indicated by broken-line arrows in FIG. 6, the two insertion portions 132 of the frame 101 are substantially horizontally inserted into the corresponding holes 32 of the holder 30 obliquely from the upper side, and thereafter, the two insertion portions 131 for snap-fit are inserted into the corresponding holes 31 of the holder 30, whereby the storage bag 100 is mounted to the holder 30. When the frame 101 of the storage bag 100 is mounted to the apparatus and banknotes are stored in the bag body 102 of the storage bag 100, the upper surface of the frame member 101a and the upper surface of the frame member 101b form a stacking surface on which the banknotes are stacked. Preferably, the upper surface of the frame member 101a and the upper surface of the frame member 101b are fixed to the holder 30 so as to be flush with each other and form a substantially horizontal flat surface. Since the holes 31, 32 and insertion portions 131, 132 are formed in different insertion directions, the frame 101 can be fixed at a predetermined position with respect to the holder 30. Since the insertion portions 132 located at the front side (X-axis negative direction) of the frame 101 are substantially horizontally inserted in the holes 132 at the front side of the holder 30 while the insertion portions 131 located at the rear side of the frame 101 are substantially vertically inserted in the holes 31 at the rear side of the holder 30, the frame 101 can be easily mounted to the holder 30 by one hand.

The holder 30a and the two shafts 33, 34 shown in FIG. 6 are disposed such that the positions thereof are fixed with respect to the mounting unit 20. The two shafts 33, 34 are respectively inserted in the through-holes formed in the holder 30b. The holder 30b is driven by a holder driving unit to move in parallel along the shafts 33, 34 as indicated by a solid-line arrow shown in FIG. 6. One holder 30b moves toward the other holder 30a with the frame 101 being mounted thereto. Thus, as shown in FIGS. 5A and 5B, the connecting portions 111 of the frame member 101a are connected to the connecting portions 112 of the frame member 101b to close the opening 103 of the frame 101, whereby the opening of the storage bag 100 can be closed.

After the opening of the storage bag 100 is closed, the storage bag 100 can be removed from the holder 30 through a procedure opposite to the procedure for mounting the frame 101 to the holder 30. Specifically, the two insertion portions 131 are held from outside by one hand to release the engagement of snap-fit and is pulled out upward from the holes 31. Furthermore, the insertion portions 132 are pulled out rearward (X-axis positive direction) from the holes 32, whereby the frame 101 can be removed from the holder 30.

FIGS. 7A to 7C illustrate stacking and storage of banknotes. In FIGS. 7A to 7C, illustration of some components including the holder 30 is omitted. An unused folded bag body 102 is inserted in a gap between the two opposing members 40a, 40b of the stage 40 as shown in FIG. 7A, and the frame 101 is fixed to the holder 30 as described with reference to FIG. 6. As shown in FIG. 7B, banknotes 200 are stacked on the upper surface of the frame 101 fixed to the holder 30. As shown in FIG. 7C, the banknotes 200 stacked on the frame 101 are pushed by the pushing member 50 into the storage bag 100 through the opening 103 of the frame 101, and are stored inside the storage bag 100. The opening 103 of the frame 101 is formed such that, even when the stacked banknote 200 is shifted to one side in the lateral direction, one long edge of the banknote 200 is located on one member 101a of the frame 101 while the other long edge of the banknote 200 is located on the other member 101b of the frame 101. That is, the opening 103 is formed such that, when the banknote 200 is stacked on the frame 101, both the two long edges of the stacked banknote 200 are in contact with the upper surface of the frame 101.

As shown in FIG. 7A, the bag body 102 of the storage bag 100 in which no banknotes are stored is folded. When the pushing member 50 pushes the banknotes 200 on the frame 101 into the bag body 102 through the opening 103, folded portions of the bag body 102 are unfolded and the bag body 102 is expanded, whereby a storage space for storing pushed banknotes inside the bag body 102 is formed beneath the frame 101 and above the stage 40. Since the gap of the stage 40 is wide at the both outer sides, the folded portions of the bag body 102 can be easily unfolded at these wide gaps. The storage mechanism 10 repeatedly performs the banknote stacking process shown in FIG. 7B and the banknote pushing process shown in FIG. 7C. According to the number of the banknotes stored in the bag body 102, the folded bag body 102 gradually expands downward to increase the storage space formed inside the bag body 102 for storing the pushed banknotes. The stage 40 moves downward as the storage space is increased.

As shown in FIG. 7A, a plurality of detection areas 120 (120a, 120b) to receive and reflect detection light are disposed on the upper surface of the frame 101. Specifically, the detection area 120a is disposed on the upper surface of the frame member 101a while the detection area 120b is disposed on the upper surface of the frame member 101b. For example, the detection areas 120a, 120b are formed by attaching mirror-finished flat members to the upper surfaces of the frame members 101a, 101b, respectively. The storage mechanism 10 is provided with sensors corresponding to the detection areas 120a, 120b, respectively. Each sensor irradiates the corresponding detection area 120 with detection light emitted from a light emitter, and receives the detection light reflected from the detection area 120 by a light receiver. When there is no banknote on the frame 101 as shown in FIG. 7A, the detection light is reflected by the detection area 120. When the banknote 200 is stacked on the upper surface of the frame 101 as shown in FIG. 7B, at least a part of the detection area 120 is covered with the banknote 200, and the intensity of the reflected light of the detection light changes. The banknote handling apparatus 1 can detect presence/absence of the banknote 200 on the frame 101, based on the change in the detection light. For example, if a banknote, which has not been stored in the storage bag 100 and is left on the frame 101 after the pushing process to store banknotes in the storage bag 100, is detected by the sensor, the banknote handling apparatus 1 performs the pushing process again to store this banknote into the storage bag 100.

FIG. 8 shows a part of the storage mechanism 10. Preferably, as shown in FIG. 8, a pushing film 52 is disposed on a longitudinal side surface of the pushing member 50. The pushing film 52 is a member for assisting the pushing process by the pushing member 50, which will be described later in detail.

The banknote handling apparatus 1 closes the opening 103 by closing the gate of the frame 101 when the number of banknotes stored in the storage bag 100 has reached a predetermined upper limit. The opening of the storage bag 100 is closed by closing the opening 103 of the frame 101. Even when the number of banknotes stored in the storage bag 100 has not yet reached the upper limit, the banknote handling apparatus 1 closes the opening of the storage bag 100 if the upper end of the stored banknotes has reached a predetermined position in the storage bag 100. As shown in FIG. 8, the storage mechanism 10 includes a detection member 70 for detecting the upper end of the banknotes stored in the storage bag 100. For example, the detection member 70 is a lever having a thin plate shape. The pushing member 50 has a through-hole 50a formed at the position corresponding to the detection member 70. The detection member 70 is disposed in the through-hole 50a at substantially the center in the lateral direction (Y-axis direction) of the pushing member 50. When the pushing member 50 is at the retracted position above the stacking area as shown in FIG. 3, the detection member 70 is retracted inside the pushing member 50. When the pushing member 50 moves from the retracted position to the pushing position, the detection member 70 comes out from the through-hole 50a.

Preferably, the storage mechanism 10 further includes a pressing member 80 for pressing the banknotes stored in the storage bag 100. For example, the pressing member 80 is a lever having thin plate shape and is disposed outside the lateral side surface of the pushing member 50. The shape of the pressing member 80 and the position of the pressing member 80 with respect to the pushing member 50 are examples and these are not particularly limited. When the gate of the frame 101 of the storage bag 100 is closed, the banknotes stored in the storage bag 100 are pressed downward from the upper side by the pressing member 80 so as not to be sandwiched between the two frame members 101a, 101b of the frame 101.

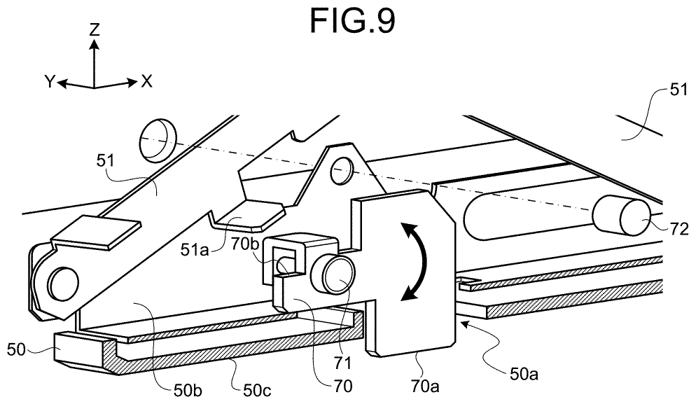

FIG. 9 illustrates the detection member 70. An example of the detection member 70 is shown in FIG. 9. The configuration of the detection member 70 is not particularly limited as long as it can detect whether or not the upper end of the banknotes stored in the storage bag 100 has reached the predetermined position. FIG. 9 shows a cross-sectional view of the pushing member 50. As shown in FIG. 9, a shaft 71 having an axis along the Y-axis direction is fixed to a frame 50b of the pushing member 50. The detection member 70 is pivotable around the shaft 71 as indicated by an arrow in FIG. 9.

FIG. 9 shows a state where the pushing member 50 is at a detection position between the retracted position where the pushing member 50 is located above the frame 101 of the storage bag 100 and the pushing position where the pushing member 50 is located beneath the frame 101 of the storage bag 100. While the pushing member 50 is at the detection position, the banknote handling apparatus 1 detects, by using the detection member 70, whether or not the upper end of the banknotes being stored in the storage bag 100 has reached the predetermined position.

As shown in FIG. 9, when the pushing member 50 is at the detection position, a storage claw 51a formed on the arm 51 is away from the detection member 70, and the detection member 70 can freely pivot within a predetermined range around the shaft 71. As shown in FIG. 9, when there is no banknote in contact with the detection member 70, a part of the detection member 70 is in contact with a part of the pushing member 50, and the detection member 70 stops at a predetermined position where a lower surface (detection surface) 70a for detecting a banknote becomes parallel to a lower surface (pushing surface) 50c of the pushing member 50.

A sensor 72 which emits and receives detection light is disposed such that the detection light passes a position above the detection member 70 when there is no banknote in contact with the detection member 70, as indicated by an alternate long and short dash line in FIG. 9. When the upper end of the banknotes stored in the storage bag 100 has reached the predetermined position, the detection member 70 is pushed up by the banknotes. As a result, the detection member 70 pivots counterclockwise around the shaft 71 and blocks the detection light emitted from the sensor 72. The banknote handling apparatus 1 detects whether or not the upper end of the banknotes stored in the storage bag 100 has reached the predetermined position, based on change between the transmitted detection light and the blocked detection light.

When the pushing member 50 moves from the detection position shown in FIG. 9 to the retracted position above the detection position, the storage claw 51a formed on the arm 51 comes into contact with a back surface part 70b of the detection member 70. The detection member 70, whose back surface part 70b is pressed downward by the storage claw 51a, pivots counterclockwise around the shaft 71 and is retracted inside the pushing member 50.

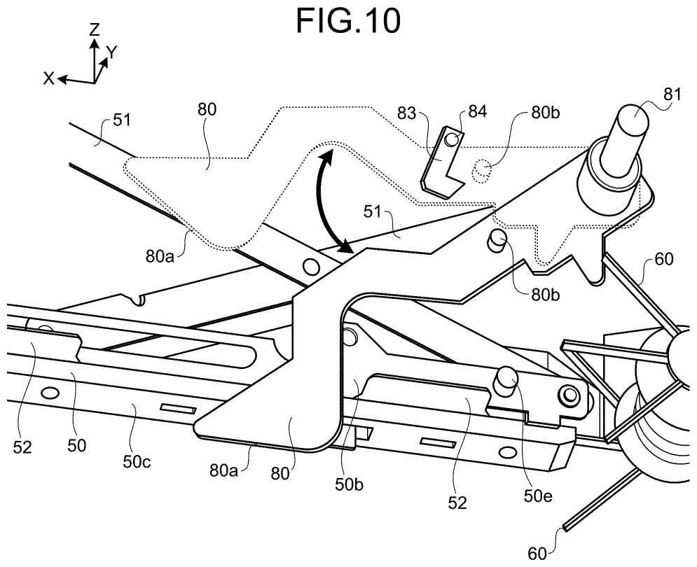

FIG. 10 illustrates the pressing member 80. An example of the pressing member 80 is shown in FIG. 10. The configuration of the pressing member 80 is not particularly limited as long as it can press the banknotes being stored in the storage bag 100 from the upper side toward the lower side. In FIG. 10, the pressing member 80 released from a locking member 83 is indicated by a solid line, and the position of the pressing member 80 locked by the locking member 83 is indicated by a broken line.

As shown in FIG. 10, a shaft 81 having an axis along the Y-axis direction is fixed to the storage mechanism 10. The pressing member 80 is pivotable around the shaft 81 as indicated by an arrow in FIG. 10. Preferably, the pressing member 80 is urged downward by an urging member. The urging member is preferably an elastic member, and more preferably a spring member. For example, the pressing member 80 is urged by the spring member in the counterclockwise direction around the shaft 81.

The pressing member 80 released from the locking member 83 is urged by the spring member and pivots in the counterclockwise direction around the shaft 81. A part of the pressing member 80 urged by the spring member comes into contact with a part of the storage mechanism 10, whereby the pressing member 80 stops at a position indicated by the solid line in FIG. 10. The pressing member 80 stops at the position where a lower surface (pressing surface) 80a thereof becomes parallel to the pushing surface 50c of the pushing member 50.

When the pushing member 50 moves upward from the position shown in FIG. 10, a storage shaft 50e formed on the frame 50b of the pushing member 50 also moves upward. While the storage shaft 50e is away from the pressing member 80, the pressing member 80 stops to presses the banknotes. After the pushing member 50 has moved upward and the storage shaft 50e has come into contact with the pressing member 80, the pressing member 80 is pushed upward by the storage shaft 50e as the pushing member 50 further moves upward. When the pressing member 80 has been pushed upward to the position indicted by the broken line in FIG. 10, the locking member 83 locks the pressing member 80.

The locking member 83 having an L shape is pivotable around a shaft 84 that is fixed to the storage mechanism 10 and has an axis along the Y-axis direction. A driving unit drives the locking member 83 to pivot. The locking member 83 pivots counterclockwise from the position shown in FIG. 10, and is engaged with a shaft 80b of the pressing member 80 indicated by the broken line, thereby locking the pressing member 80. The banknote handling apparatus 1 can repeat the pushing process of pushing the banknotes stacked on the frame 101 into the storage bag 100, by moving the pushing member 50 in the up-down direction while the pressing member 80 is locked by the locking member 83. When closing the opening of the storage bag 100, the banknote handling apparatus 1 releases the pressing member 80 from the locking member 83. The released pressing member 80 is urged by the spring member to project downward and pivot to the position indicated by the solid line in FIG. 10, and the banknotes are pressed by the released pressing member 80.

Next, the pushing process in which the banknote handling apparatus 1 pushes the banknotes 200 stacked on the frame 101 of the storage bag 100 into the storage bag 100 by using the pushing member 50, will be described. FIGS. 11A to 11D schematically illustrate the pushing process.

As shown in FIG. 11A, the banknotes 200 transported from the transport unit 5 are stacked on the frame 101. The pushing member 50 is at the retracted position above the frame 101 so as not to interfere with stacking of the banknotes onto the frame 101. The banknote handling apparatus 1 stacks the banknotes 200 transported by the transport unit 5, one by one, onto the frame 101 of the storage bag 100 attached to the holder 30.

A width d3 of the opening 103 shown in FIG. 11A is smaller than the width (short edge dimension) of the banknotes 200 stacked on the upper surface of the frame 101. The opening 103 is formed such that the left end of the banknotes 200 is away from the left end of the opening 103 even when the banknotes 200 are stacked on the rightmost side on the frame 101, and the right end of the banknotes 200 is away from the right end of the opening 103 even when the banknotes 200 are stacked on the leftmost side on the frame 101. Thus, the banknotes 200 fed into the stacking area by the stacking wheels 60 are reliably stacked on the frame 101, and do not fall into the storage bag 100 through the opening 103 unless the banknotes 200 are pushed by the pushing member 50.

As shown in FIG. 11A, at the both ends of the frame 101 in the lateral direction, projections 101d are formed so as to project upward from the upper surface of the frame 101 on which the banknotes 200 are stacked. The projections 101d are formed along the longitudinal side surface of the frame 101. Since the projections 101d are in contact with at least parts of the side walls of the storage mechanism 10 to fill the gap between the frame 101 and the storage mechanism 10, the banknotes 200 are prevented from jumping out through the gap between the storage mechanism 10 and the frame 101.

The stage 40 is urged upward by the spring member. Therefore, the banknotes 201 stored in the storage bag 100 are pushed upward by the stage 40 and are pressed against the lower surface of the frame 101 as shown in FIG. 11A. Since the banknotes 201 stored in the storage bag 100 are compressed in the up-down direction while being sandwiched between the upper surface of the stage 40 and the lower surface of the frame 101 via the storage bag 100, the aligned state of the banknotes 201 is maintained.

A width d1 of the pushing surface of the pushing member 50 that comes into contact with the upper surface of the banknotes during the pushing process is smaller than the width d3 of the opening 103 (d1<d3). The pushing member 50 is movable in the up-down direction at a substantially center position in the width direction of the opening 103. Preferably, the pushing film 52 is attached to a lower end of the pushing member 50. The pushing film 52 is formed of a thin resin material that is elastically deformable. For example, a polyester film having a thickness of about several hundred μm is used as the pushing film 52. The pushing film 52 is configured such that both outer edges thereof in the width direction (Y-axis direction) are positioned outside the opening 103. When the pushing member 50 passes through the opening 103, the pushing film 52 can also pass through the opening 103 because it is elastically deformable.

As shown in FIG. 11A, a width d2 of the pushing film 52, i.e., a distance d2 between the both outer edges of the pushing film 52, is greater than the width d3 of the opening 103 (d2>d3). For example, the width d1 is about 15 mm, the width d2 is about 40 mm, and the width d3 is about 30 mm.

When the number of the banknotes 200 stacked on the frame 101 has reached a predetermined number (e.g., 10), the banknote handling apparatus 1 suspends stacking of banknotes onto the frame 101, and pushes, by using the pushing member 50, the stacked banknotes 200 into the storage bag 100. The banknote handling apparatus 1 moves the pushing member 50 downward from the retracted position as shown in FIG. 11B. The pushing member 50 moving downward pushes the banknotes 200 into the opening 103 of the opened gate. For example, the banknotes 200 are curved while being pushed into the opening 103. The pushing film 52 passes through the opening 103 of the opened gate while being elastically deformed at the both outer edges. The both outer edges of the pushing film 52 elastically deform so as to curve upward.

The both outer edges of the pushing film 52 come into contact with the inner wall of the opening 103 of the opened gate when there is no banknote. That is, the pushing film 52 is formed to fill the gap between the pushing member 50 and the frame 101 when the pushing member 50 passes through the opening 103 of the opened gate. Thus, when the pushing member 50 pushes the banknotes 200 through the opening 103 of the opened gate as shown in FIG. 11B, the banknotes 200 are reliably pushed into the storage bag 100.

As shown in FIG. 11C, the pushing member 50 moves to the pushing position that is a predetermined distance beneath the lower surface of the frame 101. The banknotes 200 pushed into the storage bag 100 by the pushing member 50 are pressed against the upper surface of the banknotes 201 already stored in the storage bag 100. In this step, the stage 40 urged by the spring member is pushed downward from the position where the stage 40 has supported the banknotes 201. The pushing member 50 having reached the pushing position moves upward and returns to the retracted position again as shown in FIG. 11D. The pushing film 52 passes through the opening 103 of the opened gate while being elastically deformed such that the both outer edges curve downward. After the banknotes 200 have been stored, the stage 40 urged by the spring member moves upward, and the upper surface of the uppermost banknote among the banknotes 200 newly stored in the storage bag 100 is pressed against the lower surface of the frame 101. The banknotes 200, 201 sandwiched between the frame 101 and the stage 40 are compressed in the up-down direction. After the pushing process is completed and the pushing member 50 returned to the retracted position, the banknote handling apparatus 1 resumes the stacking of banknotes onto the frame 101.

The banknote handling apparatus 1 repeats the banknote stacking process and the stacked-banknote pushing process to store the banknotes stacked on the frame 101 into the storage bag 100 by a predetermined number of banknotes. For example, when twenty-three banknotes are to be stored in the storage bag 100, the banknote handling apparatus 1 performs, two times, a process of stacking ten banknotes on the frame 101 and pushing the stacked ten banknotes into the storage bag 100. Then, the banknote handling apparatus 1 performs, one time, a process of stacking three banknotes on the frame 101 and pushing the stacked three banknotes into the storage bag 100 to store all the banknotes in the storage bag 100.

The banknote handling apparatus 1 performs a sealing process of closing the opening 103 as shown in FIGS. 5A and 5B when a predetermined condition is satisfied. Start conditions for automatically starting the sealing process include: the number of banknotes stored in the storage bag 100 having reached a predetermined number; the uppermost banknote, among the banknotes stored in the storage bag 100, having reached a predetermined position; and the stage 40 having reached a predetermined position. When one of the three conditions is satisfied, the banknote handling apparatus 1 performs the sealing process. Alternatively, the sealing process can be manually performed through an operation performed on an operation unit of the banknote handling apparatus 1 or on an operation terminal connected to the banknote handling apparatus 1. When an operation instructing start of the sealing process has been made, the banknote handling apparatus 1 performs the sealing process. The sealing process may be automatically or manually performed, and is not limited to either one method.

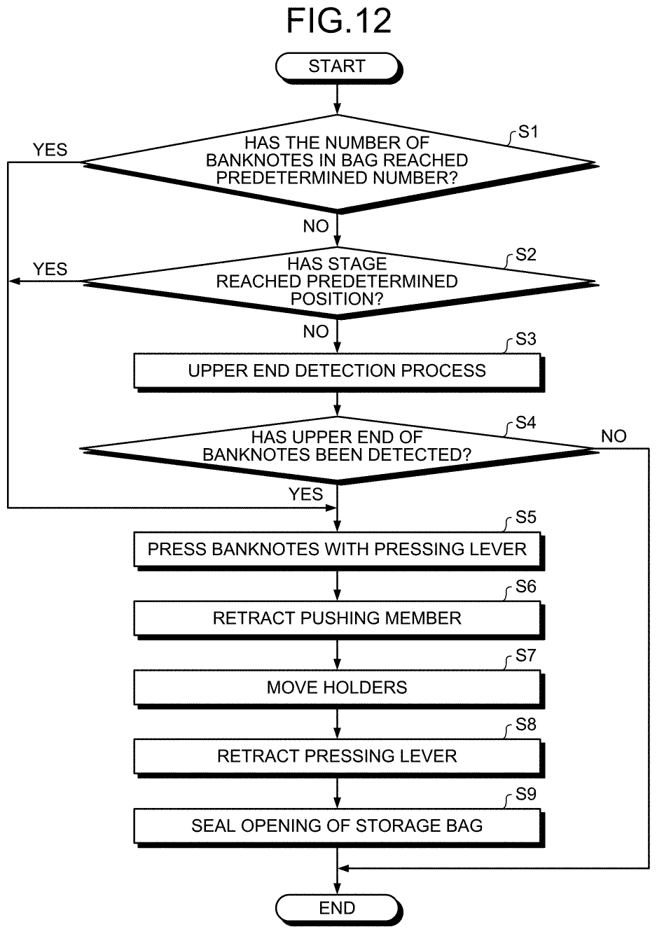

FIG. 12 is a flowchart of the sealing process. Each time the banknote handling apparatus 1 performs the pushing process shown in FIGS. 11A to 11D, the banknote handling apparatus 1 determines whether or not the number of banknotes stored in the storage bag 100 has reached a predetermined number. When the number of banknotes in storage bag 100 has reached the predetermined number through repetition of the pushing process, the banknote handling apparatus 1 performs the process shown in FIG. 12.

For example, in a case where the storage bag 100 can store therein 400 to 600 banknotes depending on the condition of the banknotes, when the number of banknotes stored in the storage bag 100 has reached 150, the process shown in FIG. 12 is started. Thereafter, the process shown in FIG. 12 is performed each time the pushing process is performed.

The banknote handling apparatus 1, which has stored the banknotes into the storage bag 100 through the pushing process, determines whether or not the number of banknotes stored in the storage bag 100 has reached an upper limit number of banknotes storable in the storage bag 100 (step S1). When the number of banknotes has reached the upper limit number (step S1; Yes), the banknote handling apparatus 1 determines that no more banknotes can be stored in the storage bag 100, and performs the sealing process (steps S5 to S9).

For example, in a case where the upper limit number of banknotes storable in the storage bag 100 is set to 450, when the number of banknotes stored in the storage bag 100 has reached 450 (step S1; Yes), the sealing process is performed.

When the number of banknotes has not yet reached the upper limit number (step S1; No), the banknote handling apparatus 1 determines whether or not the stage 40 has reached a predetermined position (step S2). The stage 40 gradually moves downward according to the number of banknotes stored in the storage bag 100. When the stage 40 has reached a predetermined lower limit position, the banknote handling apparatus 1 determines that the stage 40 has reached the predetermined position (step S2; Yes). Then, the banknote handling apparatus 1 determines that no more banknotes can be stored in the storage bag 100, and performs the sealing process (steps S5 to S9).

When the stage 40 has not yet reached the lower limit position (step S2; No), the banknote handling apparatus 1 performs an upper-end detection process (step S3). After the number of banknotes in the storage bag 100 has reached the predetermined number (e.g., 150), the upper-end detection process may not necessarily be performed each time the pushing process is performed as shown in FIG. 12. It can be set that the upper-end detection process is performed once each time the pushing process is performed a plurality of number of times. For example, the upper-end detection process may be performed each time twenty banknotes are stored in the storage bag 100. In this case, after 150 banknotes have been stored in the storage bag 100 in which up to 450 banknotes can be stored, the upper-end detection process is performed once each time a process of stacking ten banknotes on the frame 101 and pushing these ten banknotes into the storage bag 100 is performed twice.

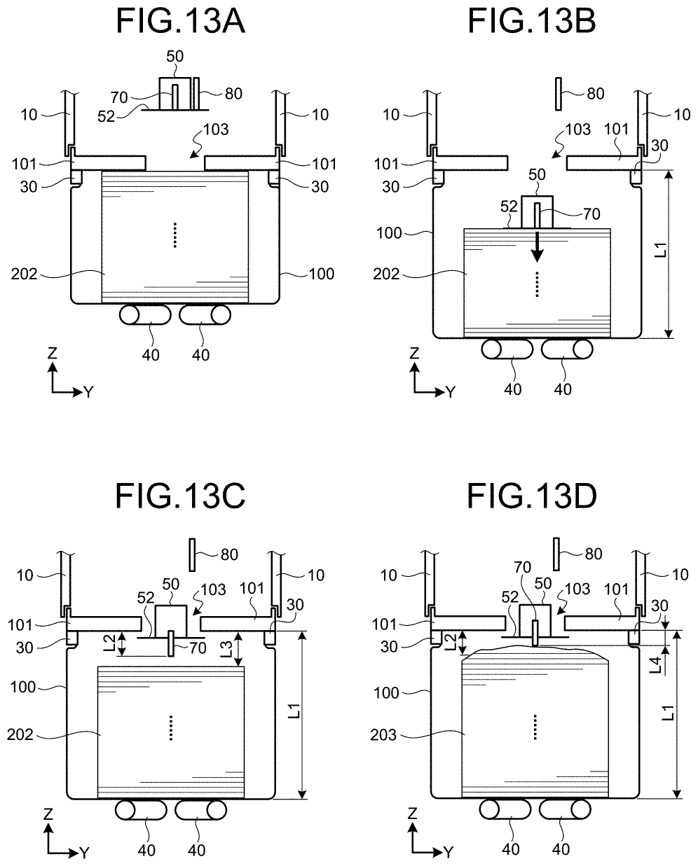

FIGS. 13A to 13D schematically illustrate the upper-end detection process. After the pushing process of pushing banknotes into the storage bag 100 has been performed, the pushing member 50 returns to the retracted position above the frame 101 as shown in FIG. 13A. The banknotes 202 are being pressed against the lower surface of the frame 101 by the stage 40 urged upward by the spring member. After the pushing process, the upper-end detection process is started. The upper-end detection process is started after the pushing member 50 returns to the retracted position as shown in FIG. 13A and it is confirmed that there is no banknotes remaining on the frame 101.

When the upper-end detection process has started, the pushing member 50 moves downward again. The pushing member 50 moves downward from the retracted position shown in FIG. 13A to push the banknotes 202. The banknotes 202 are pushed downward to a position where the upper end of the banknotes 202 is separated away from the lower surface of the frame 101 as shown in FIG. 13B. The stage driving unit causes the stage 40 to move downward and stop at a predetermined position. As shown in FIG. 13B, the stage 40 stops at a position that is a distance L1 beneath the lower surface of the frame 101, i.e., the upper surface of the holder 30.

The pushing member 50 moves upward from the position where it has pushed the banknotes 202 downward as shown in FIG. 13B, and stops at a predetermined detection position as shown in FIG. 13C. At the detection position, the detection member 70 is freely pivotable around the shaft 71 as shown in FIG. 9.

When the pushing member 50 stops at the detection position, if the banknotes 202 do not push up the detection member 70 upward, the detection member 70 does not block the detection light from the sensor 72 shown in FIG. 9, so that the upper end of the banknotes 202 is not detected. Specifically, as shown in FIG. 13C, when a distance L2 from the lower surface of the frame 101 to the detection surface 70a of the detection member 70 is smaller than a distance L3 from the lower surface of the frame 101 to the upper end of the banknotes 202 (L2<L3), the upper end of the banknotes 202 is not detected.

Even when the number of banknotes 202 shown in FIG. 13C is the same as the number of banknotes 203 shown in FIG. 13D, if the banknotes 203 include a banknote a part of which bulges due to damage or folding, the stacking height of the banknotes 203 becomes higher than the stacking height of the banknotes 202. As a result, if the banknotes 203 push up the detection member 70 upward, and the detection member 70 blocks the detection light from the sensor 72 shown in FIG. 9, the upper end of the banknotes 203 is detected. Specifically, as shown in FIG. 13D, when the detection member 70 is pushed upward by the upper end of the banknotes 203 and a distance L4 from the lower surface of the frame 101 to the detection surface 70a of the detection member 70 becomes smaller than the distance L2 shown in FIG. 13C (L4<L2), the upper end of the banknotes 203 is detected.

When the upper end of the banknotes has not been detected by the detection member 70 (FIG. 12, step S4; No), the banknote handling apparatus 1 ends the process shown in FIG. 12 without performing the sealing process (steps S5 to S9). When the upper end of the banknotes has been detected by the detection member 70 (step S4; Yes), the banknote handling apparatus 1 determines that no more banknotes can be stored in the storage bag 100, and performs the sealing process (steps S5 to S9).

As described above, the banknote handling apparatus 1 automatically performs the scaling process (steps S5 to S9) when the number of banknotes in the storage bag 100 has reached the upper limit number (step S1; Yes), when the stage 40 has reached the lower limit position (step S2; Yes), or when the upper end of banknotes has been detected by the detection member 70 through the upper-end detection process (step S4: Yes).

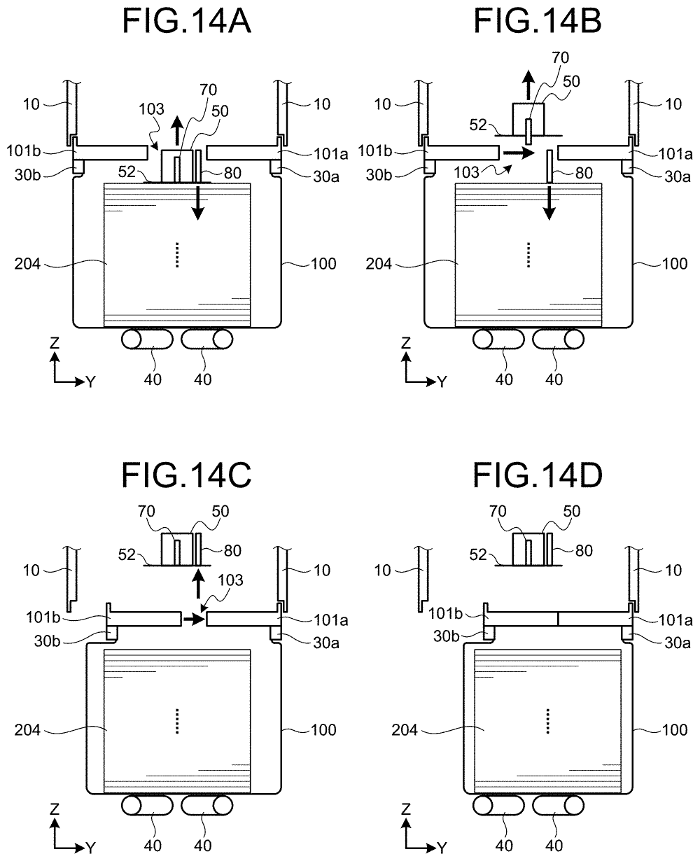

FIGS. 14A to 14D schematically illustrate the sealing process. The sealing process is a process of closing the opening of the storage bag 100, i.e., the opening 103 of the frame 101. After the pushing process or the upper-end detection process, the sealing process is started. The sealing process is started after the pushing member 50 returns to the retracted position and it is confirmed that there is no banknote remaining on the frame 101. After starting the sealing process, the banknote handling apparatus 1 moves the pushing member 50 downward to the pushing position as shown in FIG. 14A, and thereafter releases the pressing member 80 from the locking member 83 as indicated by the solid line in FIG. 10. As a result, as shown in FIG. 14A, the pressing member 80 urged by the spring member moves downward and presses banknotes 204 in the storage bag 100 (FIG. 12, step S5). The banknote handling apparatus 1 moves the pushing member 50 upward while the pressing member 80 continues to press the banknotes 204.

As shown in FIG. 14B, the pushing member 50 retracts to outside the storage bag 100, i.e., retracts upward away from the upper surface of the frame 101, while the pressing member 80 presses and holds the banknotes 204 (FIG. 12, step S6). After the pushing member 50 retracted to outside the storage bag 100, the holder 30b holding the frame member 101b of the frame 101 starts to move toward the holder 30a holding the frame member 101a (step S7).

As shown in FIG. 14C, while the holder 30b holding the frame member 101b is moving to close the opening 103 of the frame 101, the pressing member 80 is lifter upward by the pushing member 50 that is further moving upward from the position shown in FIG. 14B. The pressing member 80 retracts to outside the storage bag 100, i.e., retracts upward away from the upper surface of the frame 101 (FIG. 12, step S8). Specifically, as described with reference to FIG. 10, the pressing member 80 is lifted upward by the storage shaft 50e of the pushing member 50 moving upward, and is locked by the locking member 83.

The holder 30b holding the frame member 101b continues to move toward the holder 30a holding the frame member 101a while the pushing member 50 and the pressing member 80 are moving upward. Then, the connecting portions 111 of the frame member 101a are connected to the connecting portions 112 of the frame member 101b as shown in FIG. 5B, and the opening 103 of the frame 101 is closed as shown in FIG. 14D, whereby the opening of the storage bag 100 is closed (FIG. 12, step S9).

After the holder 30 has closed the opening of the storage bag 100, the mounting unit 20 is drawn out from the banknote handling apparatus 1 as shown in FIG. 1, and the storage bag 100 having the banknotes stored therein is dismounted from the mounting unit 20 and collected from the apparatus.

In the present embodiment, as shown in FIG. 6, the stage 40 is composed of the pair of opposing members 40a. 40b that are bent such that the gap therebetween is wider at the both end parts than at the center part. The configuration of the stage 40 is not limited thereto. For example, the opposing members 40a. 40b shown in FIG. 6 may be composed of only the center parts thereof having the narrow gap, and the center parts may be supported by the support member 40c. The stage 40 may not necessarily have the configuration in which the opposing members 40a, 40b are supported by the support member 40c. For example, the stage 40 may be formed by cutting out a part of a plate-shaped body in the same shape as the gap between the opposing members 40a, 40b.

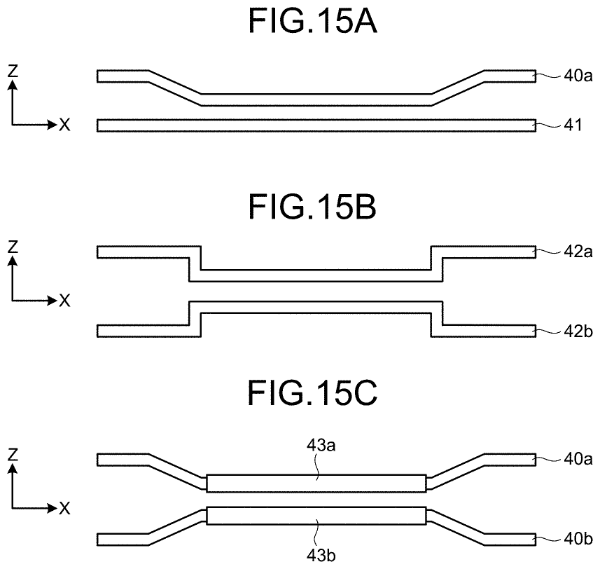

FIGS. 15A to 15C show other examples of the stage 40. As shown in FIG. 15A, only the opposing member 40a may have a bent shape while the other opposing member 41 may have a linear shape, as long as the gaps at the both outer sides are wider than the gap at the center part. The gaps at the both outer sides may not necessarily be gradually increased. As shown in FIG. 15B, a pair of opposing members 42a, 42b each being bent in a projecting shape may be disposed facing each other such that the gaps at the both outer sides are wider than the gap at the center part. In this example, one of the opposing members 42a, 42b may have a linear shape as in the example of FIG. 15A. As shown in FIG. 15C, the opposing members 40a, 40b may be inserted in hollow pipes 43a, 43b each having a circular cross-sectional circumference such that the hollow pipes 43a, 43b are rotatable at the center part where the gap is narrow. The rotatable hollow pipes 43a, 43b disposed at the center part where the gap is narrow, allow the stage 40 to easily move upward and downward even when the lower part of the bag 102 is inserted in the gap. Also, in this example, one of the opposing members 43a, 43b may have a linear shape.

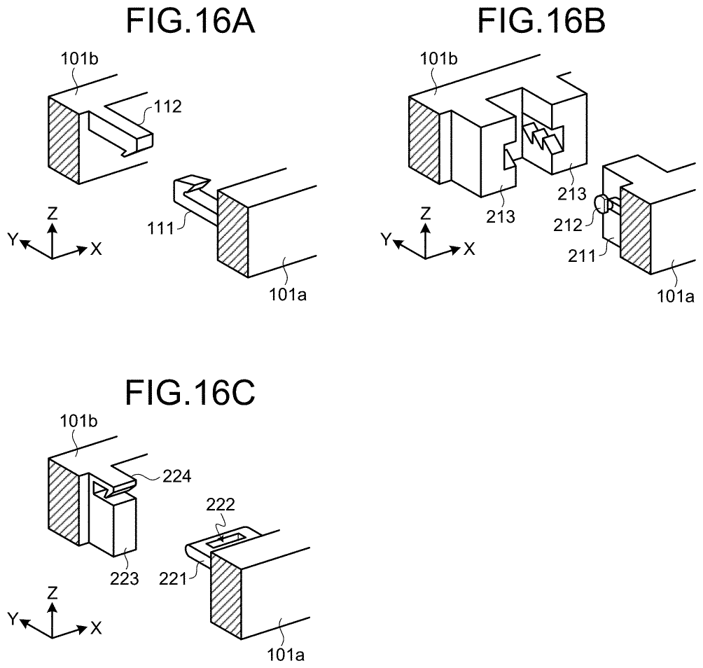

In FIGS. 5A and 5B of the present embodiment, the opening 103 is closed by using the hook-shaped connecting portions 111, 112 formed at the opposed side surfaces of the members 101a, 101b of the frame 101. The configuration for closing the frame 101 is not limited thereto. FIGS. 16A to 16C show other examples of the connecting portions for closing the frame 101. In FIGS. 5A and 5B, the projections of the connecting portions 111, 112 are formed in the longitudinal direction (X-axis direction) of the frame 101. The direction of the projections is not limited. For example, as shown in FIG. 16A, the projections may be formed in the up-down direction. For example, the width in the X-axis direction of the connecting portion 112 shown in FIG. 16A may be wider than the width in the X-axis direction of the connecting portion 111. The increased width of the connecting portion 112 facilitates connection with the connecting portion 111. The connecting portion 111 may not necessarily elastically deform to be engaged with the connecting portion 112 as long as at least one of the connecting portion 111 and the connecting portion 112 elastically deforms. Furthermore, the connecting portion 111 may not necessarily be broken when the frame 101 once closed is forcibly opened as long as at least one of the connecting portion 111 and the connecting portion 112 is broken.

As shown in FIG. 16B, projections 212 may be formed at both side surfaces of a connecting portion 211 of the member 101a while connecting portions 213, each having sawtooth-shaped grooves to engage with the projections 212, may be formed on the other member 101b. Since the projections 212 of the connecting portion 211 can be inserted into the grooves of the connecting portions 213 but cannot be pulled out from the grooves, the frame 101 can be closed by connecting the connecting portion 211 with the connecting portions 213. The shape of the shaft part of the projection 212 may be adjusted according to the material thereof such that the projection 212 is broken when the frame 101 once closed is forcibly opened.

As shown in FIG. 16C, a connecting portion 221 having a hole 222 may be formed on the member 101a while a connecting portion 223 having a hook 224 corresponding to the hole 222 may be formed on the other member 101b. Since the hook 224 of the connecting portion 223 of the member 101b can be engaged with the hole 222 of the connecting portion 221 of the member 101a but cannot be removed from the hole 222, the frame 101 can be closed by connecting the connecting portion 221 with the connecting portion 223. The shape of the root portion of the hook 224 may be adjusted according to the material thereof such that the hook 224 is broken when the frame 101 once closed is forcibly opened.

In the present embodiment, the pressing member 80 is urged by the spring member. The method for driving the pressing member 80 is not particularly limited as long as the pressing member 80 can be urged to press banknotes. For example, the pressing member 80 may be driven and urged by a driving unit using a motor or a solenoid.

In the present embodiment, banknotes are stored in the storage bag 100. Objects to be stored in the storage bag 100 are not limited to banknotes. For example, sheets such as checks, coupons, and securities may be stored in the storage bag 100. When a sheet handling apparatus for handling these sheets is provided with the storage mechanism 10, the sheets can be stored in the storage bag 100 as described above. Alternatively, for example, coins may be stored in the storage bag 100. When a money handling apparatus for handling banknotes and coins or a coin handling apparatus for handling coins is provided with the storage mechanism 10, coins can be stored in the storage bag 100.

In one aspect of the present disclosure, a money storage container is a container in which a money handling apparatus stores money. The money storage container includes: a bag body having an opening, and configured to store the money therein through the opening; and a frame disposed at the opening of the bag body, and having a gate for opening and closing the opening. The frame is configured to be mounted to and dismounted from the money handling apparatus.

In the above configuration, the bag body may be folded when the money is not stored therein, and may be unfolded when the money is stored therein.

In the above configuration, the bag body may have a substantially flat shape when the frame is mounted to the money handling apparatus. When a plurality of pieces of the money are stored, the bag body may be expanded to a shape that allows the plurality of pieces of the money are stacked therein.

In the above configuration, the gate may include a first member and a second member disposed facing each other, and the gate may close the opening of the bag body by connecting a first connecting portion disposed on the first member with a second connecting portion, which is configured to be connectable with the first connecting portion, disposed on the second member.

In the above configuration, a plurality of the first connecting portions and a plurality of the second connecting portions may be disposed on the frame.

In the above configuration, the first connecting portions and the second connecting portions may be disposed at unequal intervals.

In the above configuration, the first member and the second member may form a stacking surface, on which a plurality of pieces of the money are stacked, when the frame is mounted to the money handling apparatus.

In the above configuration, the frame may have a shape that prevents the money stacked on the first member and the second member from jumping out from the frame.

In the above configuration, both ends of the first member may be connected to both ends of the second member by bendable connection members, respectively. When the connection members are bent, the first member and the second member may approach each other and the first connecting portion may be connected to the second connecting portion.

In the above configuration, at least one of the first connecting portion and the second connecting portion may have a shape that elastically deforms when the gate of the frame is closed.

In the above configuration, when the gate of the frame is opened after the first connecting portion and the second connecting portion have been connected to each other to close the gate, at least one of the first connecting portion and the second connecting portion may be broken.

In the above configuration, the first connecting portion and the second connecting portion may have hook shapes that are engaged with each other when the gate of the frame is closed.

In the above configuration, the frame may be mounted to and dismounted from the money handling apparatus by means of snap-fit.

In the above configuration, the frame may include insertion portions respectively corresponding to at least one hole formed substantially in a horizontal direction in the money handling apparatus and at least one hole formed substantially in a vertical direction in the money handling apparatus. The frame may be mounted to the money handling apparatus by inserting the insertion portions in the corresponding holes of the money handling apparatus.

In the above configuration, at least one hole formed in the money handling apparatus and the insertion portion of the frame corresponding to the hole may constitute a snap-fit structure.

In the above configuration, the money may be a banknote.

In one aspect of the present disclosure, a money handling apparatus includes: a mounting unit to/from which the money storage container having the above configuration is mounted/dismounted; and a storage mechanism configured to store the money in the money storage container, and close the opening after storing the money.

The money storage container according to the present disclosure has the configuration suitable for use in the money handling apparatus, and the money handling apparatus can easily perform the process of storing money in the money storage container.

As described above, the storage bag 100 according to the present embodiment can be easily mounted/dismounted to/from the mounting unit 20 of the banknote handling apparatus 1. The banknote handling apparatus 1 can stack banknotes on the frame 101 of the storage bag 100. The banknote handling apparatus 1 can store a plurality of stacked banknotes simultaneously into the storage bag 100 from the opening 103 of the frame 101. When no more banknotes can be stored in the storage bag 100, the banknote handling apparatus 1 can close the frame 101 of the storage bag 100 so as to prevent the stored banknotes from getting out of the storage bag 100.

1. A money storage container in which a money handling apparatus stores money, the money storage container comprising:
a bag body having an opening, the bag body configured to store the money therein through the opening; and
a frame disposed at the opening of the bag body, the frame having a gate for opening and closing the opening, wherein
the frame is configured to be mounted to and dismounted from the money handling apparatus.

2. The money storage container according to claim 1, wherein the bag body is folded when the money is not stored therein, and is unfolded when the money is stored therein.

3. The money storage container according to claim 2, wherein
the bag body has a substantially flat shape when the frame is mounted to the money handling apparatus, and
when a plurality of pieces of the money are stored, the bag body is expanded to a shape that allows the plurality of pieces of the money are stacked therein.

4. The money storage container according to claim 1, wherein
the gate includes a first member and a second member disposed facing each other, and
the gate closes the opening of the bag body by connecting a first connecting portion disposed on the first member with a second connecting portion, which is configured to be connectable with the first connecting portion, disposed on the second member.

5. The money storage container according to claim 4, wherein a plurality of the first connecting portions and a plurality of the second connecting portions are disposed on the frame.

6. The money storage container according to claim 5, wherein the first connecting portions and the second connecting portions are disposed at unequal intervals.

7. The money storage container according to claim 4, wherein the first member and the second member form a stacking surface, on which a plurality of pieces of the money are stacked, when the frame is mounted to the money handling apparatus.

8. The money storage container according to claim 7, wherein the frame has a shape that prevents the money stacked on the first member and the second member from jumping out from the frame.

9. The money storage container according to claim 4, wherein
both ends of the first member are connected to both ends of the second member by bendable connection members, respectively and
when the connection members are bent, the first member and the second member approach each other and the first connecting portion is connected to the second connecting portion.

10. The money storage container according to claim 4, wherein at least one of the first connecting portion and the second connecting portion has a shape that elastically deforms when the gate of the frame is closed.

11. The money storage container according to claim 4, wherein when the gate of the frame is opened after the first connecting portion and the second connecting portion have been connected to each other to close the gate, at least one of the first connecting portion and the second connecting portion is broken.

12. The money storage container according to claim 4, wherein the first connecting portion and the second connecting portion have hook shapes that are engaged with each other when the gate of the frame is closed.

13. The money storage container according to claim 1, wherein the frame is mounted to and dismounted from the money handling apparatus by means of snap-fit.

14. The money storage container according to claim 1, wherein
the frame includes insertion portions respectively corresponding to at least one hole formed substantially in a horizontal direction in the money handling apparatus and at least one hole formed substantially in a vertical direction in the money handling apparatus, and
the frame is mounted to the money handling apparatus by inserting the insertion portions in the corresponding holes of the money handling apparatus.

15. The money storage container according to claim 14, wherein at least one hole formed in the money handling apparatus and the insertion portion of the frame corresponding to the hole, constitute a snap-fit structure.

16. The money storage container according to claim 1, wherein the money is a banknote.

17. A money handling apparatus comprising:
a mounting unit to which the money storage container according to claim 1 is mounted and/or dismounted; and
a storage mechanism configured to store the money in the money storage container, and close the opening after storing the money.
